(19) United States
(12) Patent Application Publication
(10) Pub. No.: US 2008/0001401 A1
(43) Pub. Date: Jan. 3, 2008

(54) METHOD AND APPARATUS FOR PREVENTING OVERINSERTION IN PLASTIC PIPE SYSTEMS

(76) Inventors: Guido Quesada, San Jose (CR); Shahriar Rahman, Fort Worth, TX (US)

Correspondence Address: Charles D. Gunter, Jr.;Whitaker, Chalk. Swindle & Sawyer, LLP, STE 3500, 301 Commerce Street, Frot Worth, TX, 76102-4186, US

(21) Appl. No.: 11/751,310

(22) Filed: May 21, 2007

Related U.S. Application Data
(60) Provisional application No. 60/808,483, filed on May 25, 2006.

(51) Int. Cl. F16L 37/00

(52) U.S. Cl. 285/260

(57) ABSTRACT

A method is shown for joining and sealing a female plastic pipe end having a belled end opening to a mating male plastic pipe end having an interior surface and an exterior surface. A sealing element is installed within a groove formed in the belled end of the female pipe section. The male pipe end is then inserted into the end opening of the female pipe end so that the elastomeric sealing gasket makes sealing contact with the exterior surface of the male pipe. A control mechanism controls the distance the male pipe travels longitudinally within the end opening of the female plastic pipe to prevent overinsertion of the male pipe within the female pipe opening.

### CROSS REFERENCE TO RELATED APPLICATIONS

The present application claims priority from earlier filed provisional application Ser. No. 60/808,483, filed May 25, 2006, entitled “Method and Apparatus for Preventing Overinsertion in Plastic Pipe Systems,” by Guido Quesada and Shah Rahman.

### BACKGROUND OF THE INVENTION

1. Field of the Invention

The present invention relates generally to the field of plastic pipe systems of the type used in the municipal water works industry and similar applications, and in particular, to methods and devices for preventing problems caused by overinsertion of the spigot pipe end within the mating belled pipe end in making a secure connection between two plastic pipes in a pipeline.

2. Description of the Related Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, ductile iron, and most recently, plastic including the various polyolefins and PVC.

It is well known in the art to extrude plastic pipes in an elongated cylindrical configuration of a desired diameter and to then cut the extruded product into individual lengths of convenient size suitable for handling, shipping and installation. In a typical application, each length of pipe is enlarged or “belled” at one end. The end opening of the belled pipe is of a sufficient diameter to mate with the next adjacent pipe section by inserting the unenlarged or “spigot” male end of the next adjacent length of pipe within the belled end opening. The inside diameter of the belled end is formed sufficiently large to receive the mating spigot pipe end, while allowing sufficient clearance to permit the application of an elastomeric gasket, or other sealing device, designed to prevent leakage at pipe joints when a plurality of pipe lengths are joined to form a pipeline.

In addition to providing a sealing function, pipe joints, for example in a municipal application, must also typically be provided with some sort of restraint mechanism to prevent separation and to accommodate varying pressures as well as other environmental influences. There are various types of mechanisms which are commercially available and which are used to provide a restraining function at the pipe joint in a plastic pipe system. In one type of connection, the current restraint mechanism is an external clamping device which is totally separated from the sealing function. In another type of fitting connection, a gasket performs the sealing function. However, it is necessary that an external means must compress the gasket by mechanical action such as T-bolts.

U.S. Pat. No. 5,662,360, issued Sep. 2, 1997, to Guzowski, and assigned to the assignee of the present invention shows a type of “interlocked restraint” for a plastic pipe joining system. The female end connection has a radially extending indention or protrusion within the mouth opening. The male end connection has at least one radially extending protrusion or indention formed on an exterior surface. The respective indentions and protrusions matingly engage in snap fit fashion as the joint is formed by forcing the male connection axially into the female connection. Again, this reference deals with a restrained pipe joint to prevent the premature separation of the female pipe end from the male pipe end.

In addition to the problem of restraining plastic pipe joints to prevent separation of the joints in use or failure of the seal systems thereof, a separate problem is that of possible overinsertion of the male, spigot pipe end into the mating female, belled pipe end during assembly of the pipe sections into a pipeline installation. The possible problems which can result from overinsertion of the male pipe end into the female pipe end at a pipe joint have been recognized in the past. For example, see “Longitudinal Mechanics of Buried Thermoplastic Pipe. Analysis of PVC Pipes of Various Joint Types”, Rahman and Watkins, American Society of Civil Engineers Pipeline Conference 2005, Houston, Tex. Various pipeline failure analyses have been traced back to excessive stresses on the bell pipe end as a result of overinsertion of the male pipe end. This could occur, for example, where the installation contractor uses a backhoe to push several sections of plastic pipe together in forming a pipeline. Common practice is for the contractor to push up to five joints back on the pipe in forming a section of pipeline.

In spite of the fact that possible overinsertion of PVC pipe is understood to be the cause of failure in some pipeline installations, to Applicant's knowledge, no current technology exists to address this problem in the same way that various technologies exist to address the problem of restrained joints.

A need exists therefore, for a method and apparatus to prevent the inadvertent overinsertion of the male, plastic pipe end within the mating female pipe end in forming a plastic pipeline.

A need also exists for such a method and apparatus which can be simply and easily implemented without greatly increasing the cost of the pipeline installation.

### SUMMARY OF THE INVENTION

It is therefore an object of the present invention to provide a method and apparatus for preventing overinserton of plastic pipe in forming sealed connections in pipeline installations which is simple in design and dependable in operation and which does not add greatly to the cost of the sealing and restraining systems presently employed in the relevant industries.

In the method and apparatus of the invention, a female plastic pipe end having a belled end is both joined and sealed with a mating male plastic pipe end having an interior surface and an exterior surface. A sealing element is provided in the form of an elastomeric sealing gasket, the gasket being installed within an internal groove formed in the belled end of the female pipe section. Next, the male pipe end is inserted into the belled end of the female pipe end so that the elastomeric sealing gasket makes sealing contact with the exterior surface of the male pipe. A special control mechanism is provided for controlling the distance the male pipe travels longitudinally within the belled end of the female plastic pipe to thereby prevent overinsertion of the male pipe within the female pipe opening.

In one form, the control mechanism is an external stop provided on the exterior of the male plastic pipe. In another form, the control mechanism is an internal stop provided in the belled end of the female plastic pipe. In some cases, the control mechanism is only temporarily installed on the exterior of the male plastic pipe.

In another version of the invention, the female pipe bell end forms an internal socket with a socket bottom wall. An interface angle exists between the male pipe end exterior surface and the socket bottom wall. The interface angle is increased by a predetermined amount in order to provide the control mechanism for preventing overinsertion of the male pipe within the female pipe opening.

A companion restraint mechanism can also be provided for the elastomeric sealing ring which allows movement of the mating male pipe relative to the belled end of the female pipe in a first longitudinal direction but which restrains movement in a second, opposite relative direction. The restraint mechanism may also be provided with an internal shoulder which serves as an internal stop for preventing overinsertion of the male pipe within the female pipe opening. In one form of the invention, the restraint mechanism is located in the groove formed in the belled end of the female pipe section and the sealing gasket is joined to the restraint mechanism and trails outwardly from the internal groove formed in the belled pipe end along a longitudinal axis of the female pipe.

In yet another version of the invention, a special coupling is provided for joining a first and second male pipe ends. The coupling has opposing end openings each provided with a sealing groove and an installed sealing gasket. The coupling also has a centrally located stop for controlling the distance each of the male pipes travels longitudinally within the respective end openings of the coupling to thereby prevent overinsertion of the male pipe within the female pipe opening.

The above as well as additional objectives, features, and advantages of the present invention will become apparent in the following detailed written description.

### BRIEF DESCRIPTION OF THE DRAWINGS

FIG. 1 is an exploded partially sectionalized view of a pipe joint in a plastic pipeline showing the sealing ring located within the female pipe end and the mating male pipe end.

FIG. 2 is a schematic representation of the problem of overinsertion of the male plastic pipe end within the mating female pipe end in a plastic pipe system.

FIG. 3 is a partial, cross-sectional view of a portion of a pipe joint showing how the problem of overinsertion occurs.

FIG. 4 is a graphical representation of the forces involved in making up a pipe joint showing the peak in the stress curve.

FIG. 5 is a partial cross-sectional view of a pipe joint with no mechanism in place to prevent overinsertion.

FIG. 6 is a view similar to FIG. 5 but showing an external ring provided on the male pipe end to prevent overinsertion within the female pipe end.

FIG. 7 is a view similar to FIG. 6 but showing another form of protuberance on the male pipe end to prevent overinsertion.

FIG. 8 illustrates, in simplified fashion, another means of preventing overinsertion by providing an internal stop within the mating bell pipe end.

FIG. 9 is a simplified schematic of a pipe joint showing the relevant contact angles of the male and female pipe ends which can be modified to lessen the possibility of overinsertion.

FIG. 10 is another version of a mechanism to prevent overinsertion in which a modified internal restraint mechanism is utilized.

FIG. 11 is another proposed solution to the problem of overinsertion in which a special coupling is utilized to join two male pipe ends.

FIG. 12 is a view, similar to FIG. 9, in which an internal restraint mechanism is utilized along with an internal stop within the female pipe end to prevent overinsertion.

FIG. 13 is a view similar to FIG. 10, but showing a trailing seal utilized with an internal restraint mechanism and an internal stop in the female pipe end.

FIG. 14 shows, in simplified fashion, an internal restraint mechanism on the female pipe end and an external stop provided on the male pipe end.

FIG. 15 shows a modified version of the restraint mechanism of FIG. 14.

### DETAILED DESCRIPTION OF THE PREFERRED EMBODIMENT

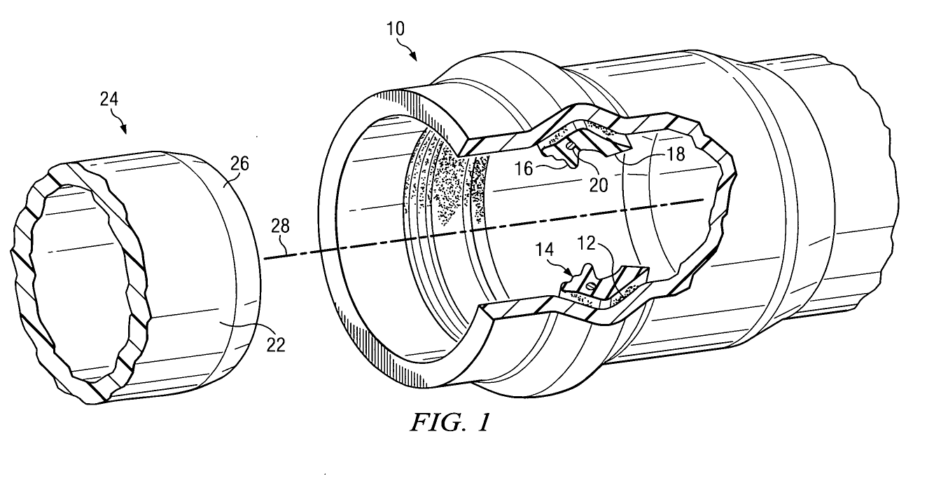

Turning to FIG. 1, there is shown an exploded view of a plastic pipe joint in which a belled female pipe end 10 is provided with an annular groove 12 for receiving an elastomeric sealing gasket 14. The annular sealing gasket 14 is a ring shaped member which, in cross section, has a compression seal region 16 and a trailing seal region 18. The gasket may be reinforced with a steel ring 20 which circumscribes the gasket body at one circumferential location. The sealing regions 16, 18 contact the exterior surface 22 of the mating male pipe section 24 upon assembly of the joint. During the assembly process, the male pipe end 24 travels to the left along the longitudinal axis 28 of the female, bell pipe end 10. Both of the pipe sections 10, 24 are formed of PVC. In the example illustrated in FIG. 1, the mating male pipe end 24 has a chamfered lip region 26. The sealing gasket is preferably made of a resilient elastomeric, thermoplastic material. For example, the sealing gasket may be formed of natural or synthetic rubber, such as SBR, or other elastomeric materials which will be familiar to those skilled in the plastic pipe arts such as EPDM or nitrile rubber. As will be apparent from the description which follows, any number of specialized sealing rings can be utilized in order to optimize the sealing function of the assembly.

The belled pipe end 10 may be formed by the so called “Rieber” process, familiar to those skilled in the waterworks industries. In the early 1970's, a new technology was developed by Rieber & Son of Bergen, Norway, referred to in the industry as the “Rieber Joint.” The Rieber system employed a combined mold element and sealing ring for sealing a joint between the socket end and spigot end of two cooperating pipes formed from thermoplastic materials. In the Rieber process, the elastomeric gasket was installed within a simultaneously formed internal groove in the socket end of the female pipe during the pipe belling process. The provision of a prestressed and anchored elastomeric gasket during the belling process at the pipe factory provided an improved socket end for a pipejoint with a sealing gasket which would not twist or flip or otherwise allow impurities to enter the sealing zones of the joint, thus increasing the reliability of the joint and decreasing the risk of leaks or possible failure due to abrasion. The Rieber process is described in the following issued United States patents, among others: U.S. Pat. Nos. 4,120,521; 4,061,459; 4,030,872; 3,965,715; 3,929,958; 3,387,992; 3,884,612; and 3,776,682.

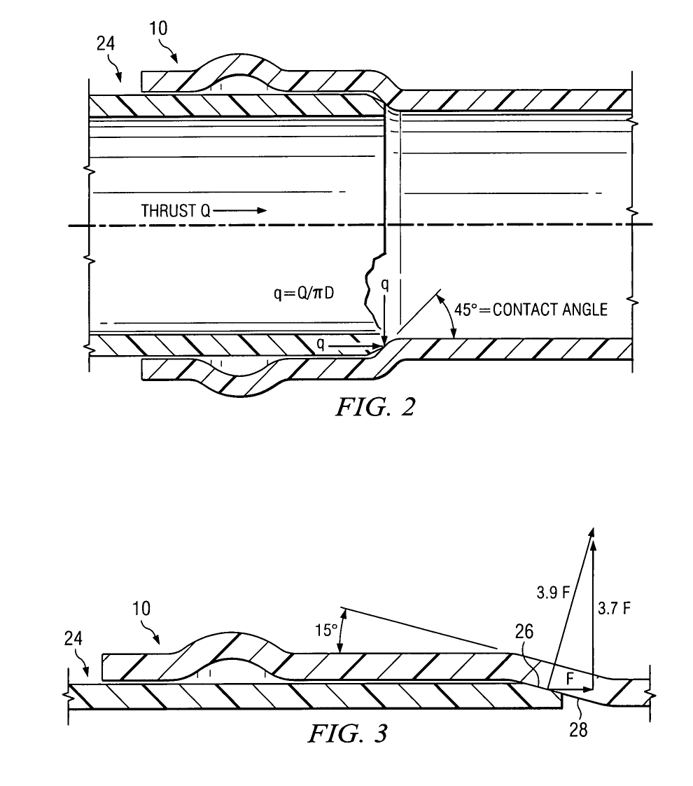

FIG. 2 of the drawings is a simplified illustration of the forces at work in a typical plastic pipeline installation which can lead to the problem of “overinsertion.” The PVC pipe joint shown in FIG. 2 is made up of a female, belled pipe section 10 and a male, spigot pipe end 24. When the spigot is “stabbed” into the mating socket to make the connection, the pipes are assembled by a thrust force “Q.” At the present time in the industry, the male pipe has a “witness mark” on its exterior surface. This mark theoretically ensures that the backhoe operator will not overinsert the male pipe into the female, belled pipe end. However, any carelessness or inadvertence on the part of the backhoe operator may result in an excessive longitudinal thrust force “Q” being applied by the spigot against the female bell. If the connection is tight, internal pressure cannot reach the gasket. As a result, internal pressure fluctuations on the spigot cause undesirable concentrated stresses against the bell. Further, if the spigot is “jammed” into the throat of the bell during assembly of the joint, allowable joint deflection is reduced by approximately one half. With reference to FIG. 2, the longitudinal thrust “Q” imposes a radial force “q” on the 45° surface illustrated, which wedges the bell end outwardly and tends to shear the bell from the pipe, the radial force being:
q=Q/πD

FIG. 3 is another simplified illustration of the assembly forces encountered during the make up of a plastic pipe connection. When the beveled end 26 of the male, spigot pipe end reaches the bottom of the socket (generally at 28 in FIG. 3), the spigot acts upon the socket as a wedge. With a typical 15° angle between the taper of the male pipe and the bottom of the bell, the wedge effect is almost a factor of four. This means that, if a net force (after that which is taken out by seal friction) reaches the bottom of the socket pipe end, the resulting radial force which is attempting to force the socket open will be approximately four times greater, e.g., 3.9 and 3.7, respectively, in FIG. 3. This may be enough force to damage the bell pipe end and compromise the connection.

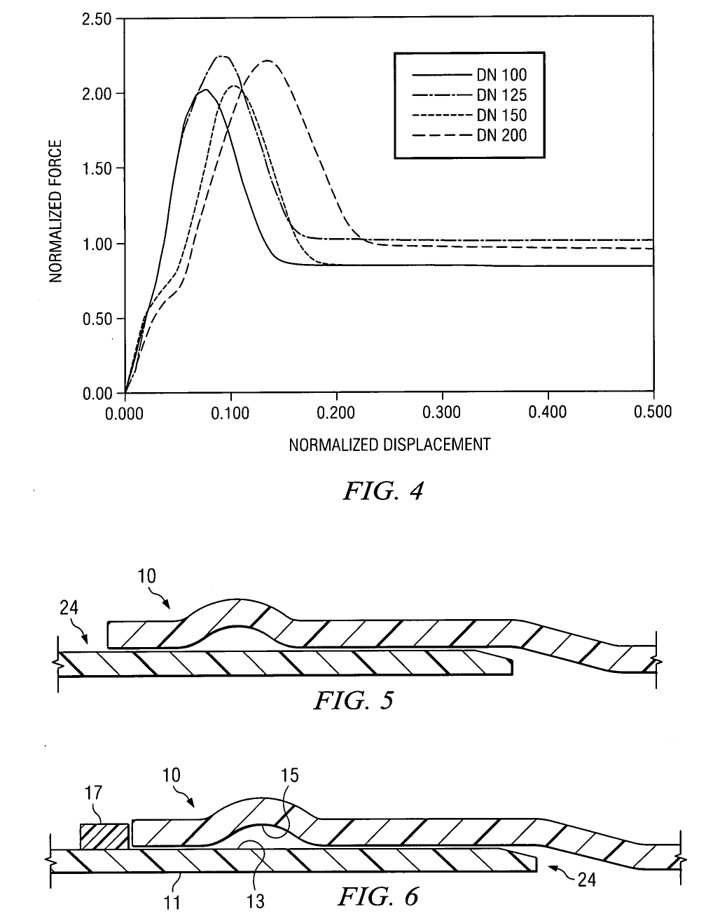

As briefly mentioned, current practice is to use a “witness mark” on the exterior surface of the male, spigot pipe end in order to lessen the possibility of overinsertion during joint make up. However, in practice, even if the male pipe is only installed up to the witness mark, overinsertion can occur on the joints immediately behind the first joint. This is due to the fact that there is a peak in the assembly force during make up, illustrated graphically in FIG. 4. As shown in FIG. 4, this peak is typically more than twice the final assembly force. When the joint reaches this peak, the force transmitted to the trailing pipes is greater than the resistance from the installed sealing gaskets. While a certain force is applied to overcome peak resistance from the sealing gasket, if the receiving pipe is not anchored, all of this force is transmitted to the joint behind. The seal in the joint behind is fully installed, so it will take out at most about 50% of this force by friction. The remainder of the force is the overinsertion force.

FIG. 5 is a schematic illustration of a typical belled pipe end 10 and mating male, spigot pipe end 24 illustrating a seal with a sustained assembly force. Theoretically, if the assembly force is sustained after it reaches the peak illustrated in FIG. 4, then the joints behind will offer at least the same resistance as the joint being assembled. This effect should theoretically reduce the incidence of overinsertion.

In the present invention, the problem of overinsertion is addressed in several different fashions, illustrated generally in FIGS. 6-15 of the drawings. For example, FIG. 6 illustrates a method of joining and sealing a female plastic pipe 10 having a belled end opening to a mating male plastic pipe end 24 having an interior surface 11 and an exterior surface 13. A sealing element is provided in the form of an elastomeric sealing gasket (such as gasket 14 in FIG. 1), the gasket being installed within a groove 15 formed in the belled end of the female pipe section. The gasket is omitted in FIGS. 6-9 for ease of illustration. To make up the pipe joint, the male pipe end is inserted into the belled end of the female pipe so that the elastomeric sealing gasket makes sealing contact with the exterior surface 13 of the male pipe 24, as previously discussed. The method of the invention differs from the traditional practice, however, in that a special “control mechanism” is provided for controlling the distance the male pipe 24 travels longitudinally within the belled end of the female plastic pipe 10 to thereby prevent overinsertion of the male pipe within the female pipe opening.

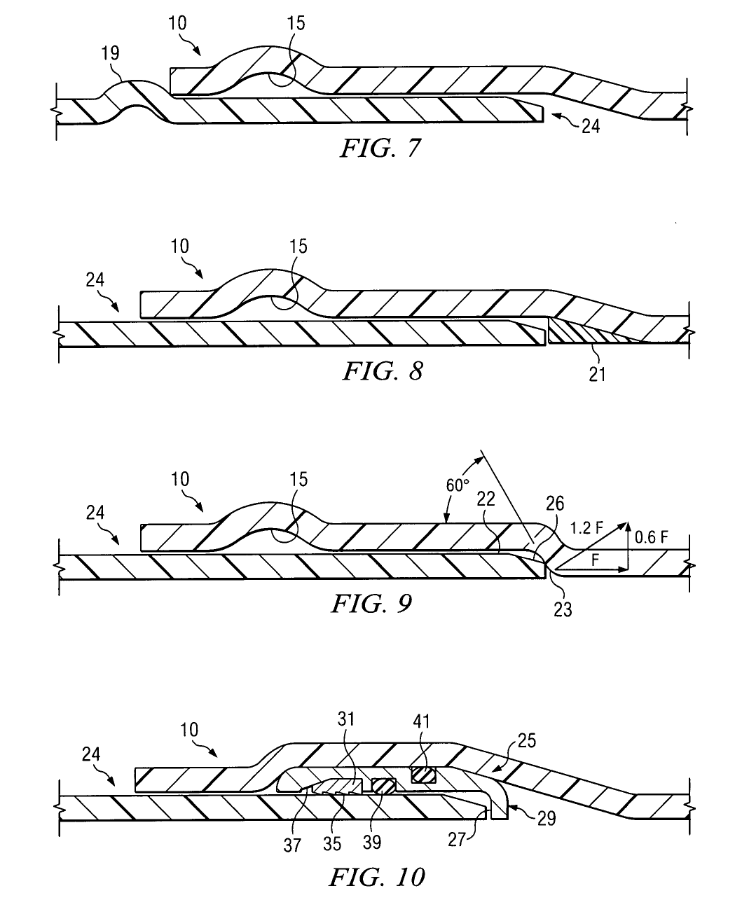

In the embodiment of the invention illustrated in FIG. 6, the special control mechanism is an external stop 17 provided on the exterior of the male plastic pipe. The stop in FIG. 6 is a circumferential rib which may be formed in any convenient fashion on the exterior of the male plastic pipe. For example, the rib could be injection molded, glued, etc. As long as the interface at the stop is perpendicular to the force, there will be no wedge effect. In some embodiments of the invention, the stop 17 might be only temporarily installed on the exterior of the pipe 24. By “temporarily” is meant that the stop 17 might be in the nature of a plastic “tie band” which would be pulled up snug on the pipe exterior. Alternatively, the stop 17 might be formed of a degradable material, such as a metal which would deteriorate, or a biodegradable material which would disintegrate over time. In FIG. 7, the control mechanism is a stop 19 in the form of an expanded region of the belled pipe end wall 24.

The control mechanism might also take the form of an internal stop (such as stop 21 in FIG. 8) provided in the bell end opening of the female plastic pipe 10. Again, the object of the stop 21 is to prevent a wedge effect during assembly of the pipe joints into a pipeline. In order for the internal stop to work effectively, it must be firmly secured, e.g., glued, within the bell end opening. Otherwise, the undesirable wedge effect could still occur.

FIG. 9 illustrates another approach to the problem in which the female pipe belled end 10 forms an internal socket with a socket bottom wall 23, and wherein an interface angle exists between the nose of the male pipe end and the socket bottom wall 23, the interface angle being increased by a predetermined amount in order to provide the control mechanism for preventing overinsertion of the male pipe within the female pipe opening. This could be accomplished by modifying the belling mandrel so that it will render a sharp angle at the bottom surface of the socket, thereby reducing the wedge effect. For example, with reference to FIG. 9, if the interface angle between the spigot and the bottom of the socket 23 is increased from 15° to 60° (i.e., the surface 23 forms a sharper angle), then the wedge effect would become about six times smaller.

FIG. 10 illustrates another approach to the problem in a pipe joint which features a combination internal sealing and restraint mechanism, illustrated generally at 25. The combination sealing and restraint mechanism 25 is generally formed as described in Applicant's copending application Ser. No. 11/120,550, filed May 3, 2005. In the embodiment illustrated, a companion restraint mechanism is provided for the elastomeric sealing ring which allows movement of the mating male pipe 24 relative to the belled end 10 of the female pipe in a first longitudinal direction but which restrains movement in a second, opposite relative direction. The restraint mechanism is also provided with an internal shoulder 27 which serves as an internal stop for preventing overinsertion of the male pipe within the female pipe opening.

In the embodiment of the device illustrated in FIG. 10, the restraint mechanism comprises a ring shaped housing 29 having a circumferential interior region and a companion ring-shaped gripping insert 31 which is contained within the circumferential interior region of the housing. The gripping insert 31 has an exterior surface and an interior gripping surface 35 with at least one row of gripping teeth for gripping the exterior surface of the male plastic pipe 24.

It will also be apparent that the gripping insert exterior surface has a sloping profile which contacts a mating interior region 37 of the housing 29, whereby contact with the exterior surface of a mating male plastic pipe causes the gripping insert to ride along the male surface at an angle while the row of gripping teeth on the gripping insert internal surface engage the exterior surface of the mating male plastic pipe. The housing 29 also carries circumferential seal elements 39, 41 for forming a seal between the interior surface of the belled pipe end 10 and the exterior surface of the male pipe 24. In this way, the internal mechanism both seals and restrains the joint while the internal shoulder 27 prevents overinsertion of the male pipe end 24 within the female belled pipe end 10.

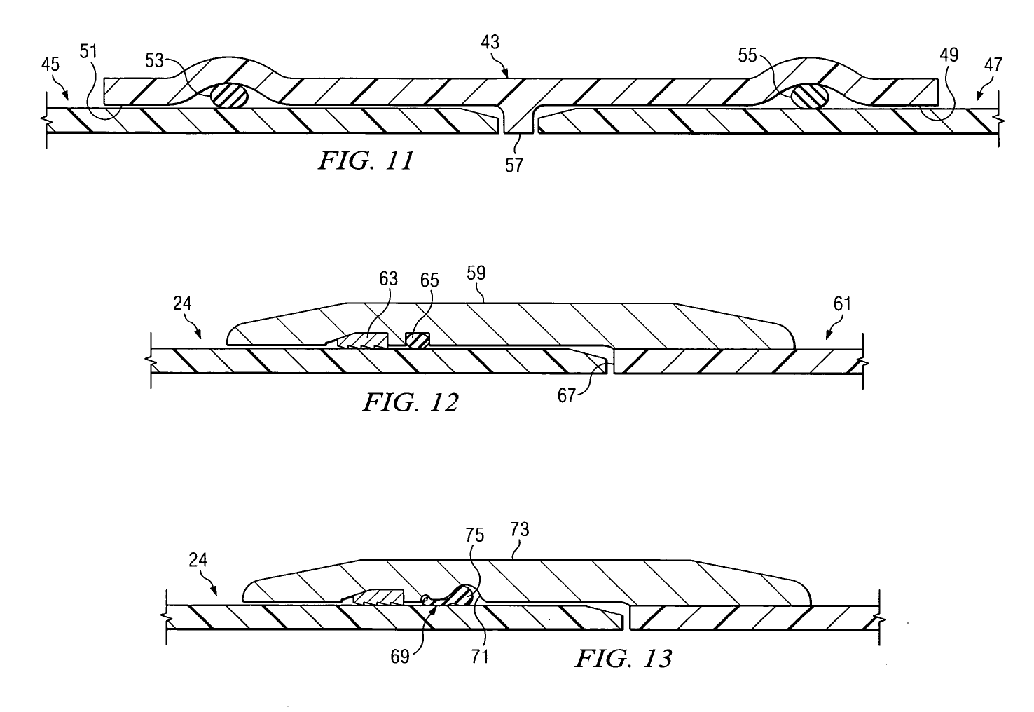

FIG. 11 illustrates another approach to the problem of overinsertion in which a coupling 43 is provided for joining a first and second male pipe ends, 45, 47, respectively. As illustrated in FIG. 11, the coupling 43 has opposing end openings 49, 51, each provided with a sealing groove and an installed sealing gasket 53, 55. The coupling 43 also has a centrally located internal stop 57 for controlling the distance each of the male pipes 45, 47 travels longitudinally within the respective end openings of the coupling to thereby prevent overinsertion of the male pipe within the female pipe opening. This arrangement would transmit the load directly from one pipe to the other without any load on the socket.

FIG. 12 shows another arrangement of a sealing and restraint joint in which a socket end 59 is glued or otherwise affixed to the end 61 of a concentric plastic pipe to thereby form a “bell.” The joint would have a restraint element such as the internal gripping ring and a sealing element such as the internal seal ring 65. The concentric pipe end 67 forms an internal stop for the mating male pipe end 24.

FIG. 13 is similar to FIG. 12 but shows the option of a tension seal, such as seal ring 69 located in the internal groove 71 of the socket 73. In this case, the seal ring 69 has a trailing bulbous region 75 for forming a seal with the male pipe end 24. The tension seal 69 allows installation without the necessity of a bevel (such as bevel 26 in FIG. 3) on the spigot pipe end 24. This would reduce cost, especially where beveling is done in the field.

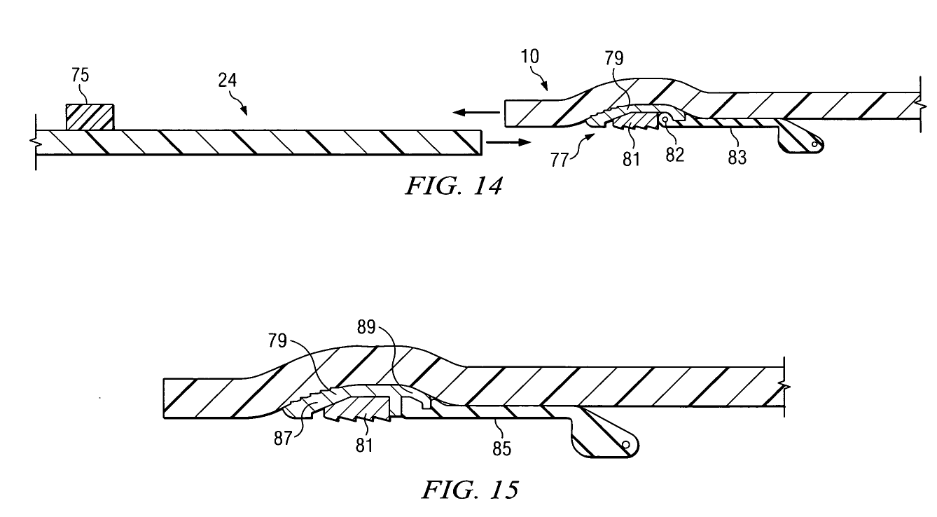

FIG. 14 illustrates an embodiment of the invention in which the male plastic pipe end 24 is provided with an external stop in the form of circumferential ring 75. The female belled end 10 has an internal groove which receives a combination sealing and restraint mechanism 77. In this case, the mechanism 77 has a circumferential housing 79 which carries an internal grip ring 81 and a trailing seal element 83. FIG. 15 shows a similar construction in which the sealing element is injected on the housing 87 and retained on the lip region 89.

The manufacture of the pipe system of FIG. 14, and its subsequent assembly into a pipe joint, will now be briefly described. With respect to the version of the invention illustrated in FIG. 14, it will be appreciated that the seal element 83 can be “snap-fit” into the housing 79. A steel ring 82 may be utilized to retain the seal element 83 in position. During the manufacturing operation, the sealing and gripping assembly is mounted onto a special forming mandrel. The grip ring 81 may be installed into the housing 79 since it doesn't touch the forming mandrel a this point. The seal element 83 is stretched until it is in position for belling. Another steel ring may be required in order to keep the seal element 83 stretched over the mandrel. A collapsible retainer or pin may be required on the mandrel in order to keep the housing 79 in position once the loader is retracted. The socket end of the female plastic pipe is then belled over the mandrel, seal element and housing as described in the previously referenced Rieber manufacturing technique, familiar to those skilled in the relevant pipe manufacturing arts. The grip ring 81 can also be installed after the pipe belling operation, if desired. The spigot leading edge is preferably smoothed. However, it is not necessary to bevel the spigot.

The male pipe end (spigot) is inserted within the female pipe belled end until it reaches a witness mark. Optionally a physical stop may be glued to the spigot. As the tension seal stretches, the assembly force increases monotonically, i.e., there is no peak force. This enables installed seals behind to resist the assembly force. The seal itself is expected to protect the socket from wedging by the spigot if it is pushed beyond the witness mark. When the assembly thrust is withdrawn, the seal element 83 pushes the spigot 24 back until the restraining device engages and holds it in position. This backward motion provides room for thermal expansion, even if a physical insertion stop is present. Restraining device engagement is shallow because the force exerted by the seal element 83 is relatively low. Therefore, there is also room for longitudinal contraction.

With respect to the version of the invention illustrated in FIGS. 14 and 15, a restrained joint is provided, which allows both expansion and contraction. Overinsertion in joints behind the one being assembled is prevented by the increasing resistance from the seal element. Room for thermal expansion is achieved, even if a physical insertion stop is built into the system. The seal element mitigates eventual wedging of the spigot against the socket. Seal kickback provides immediate restraining device engagement and verification. A spigot bevel is not necessary. The restraining insert can be installed in the housing before belling, which would simplify delivery and pipe manufacturing. The seal element can provide spring force to the restraining insert in order to aid engagement, if desired. Preferably, the housing 79 has a greater ID on the seal side. This could facilitate the installation of the grip ring 81, if the ring 81 is installed before the seal element 83.

While the invention has been shown in several of its forms, it is not thus limited but is susceptible to various changes and modifications without departing from the spirit thereof.

What is claimed is:

1. A method of joining and sealing a female plastic pipe end having a belled end with an end opening to a mating male plastic pipe end having an interior surface and an exterior surface, the method comprising the steps of:
providing a sealing element in the form of an elastomeric sealing gasket, the gasket being installed within a groove formed in the belled end of the female pipe section;
inserting the male pipe end into the end opening of the female pipe end so that the elastomeric sealing gasket makes sealing contact with the exterior surface of the male pipe;
providing a control mechanism for controlling the distance the male pipe travels longitudinally within the end opening of the female plastic pipe to thereby prevent overinsertion of the male pipe within the female pipe opening.

2. The method of claim 1, wherein the control mechanism is an external stop provided on the exterior of the male plastic pipe.

3. The method of claim 1, wherein the control mechanism is an internal stop provided in the end opening of the female plastic pipe.

4. The method of claim 2, wherein the control mechanism is only temporarily installed on the exterior of the male plastic pipe.

5. The method of claim 1, wherein the female pipe bell end forms an internal socket with a socket bottom wall, and wherein an interface angle exists between the male pipe end and the socket bottom wall, the interface angle being increased by a predetermined amount in order to provide the control mechanism for preventing overinsertion of the male pipe within the female pipe opening.

6. The method of claim 1, wherein a companion restraint mechanism is provided for the elastomeric sealing ring which allows movement of the mating male pipe relative to the belled end of the female pipe in a first longitudinal direction but which restrains movement in a second, opposite relative direction, the restraint mechanism also being provided with an internal shoulder which serves as an internal stop for preventing overinsertion of the male pipe within the female pipe end opening.

7. The method of claim 6, wherein the restraint mechanism comprises a ring shaped housing having a circumferential interior region and a companion gripping insert which is delivered with and contained within the circumferential interior region of the housing, the gripping insert having an exterior surface and an interior gripping surface with at least one row of gripping teeth for gripping the exterior surface of the male plastic pipe.

8. The method of claim 7, wherein the gripping insert exterior surface has a sloping profile which contacts a mating interior region of the housing, whereby contact with the exterior surface of a mating male plastic pipe causes the gripping insert to ride along the male surface at an angle while the row of gripping teeth on the gripping insert internal surface engage the exterior surface of the mating male plastic pipe.

9. The method of claim 1, wherein a coupling is provided for joining a first and second male pipe ends, the coupling having opposing end openings each provided with a sealing groove and an installed sealing gasket, the coupling also having a centrally located stop for controlling the distance each of the male pipes travels longitudinally within the respective end openings of the coupling to thereby prevent overinsertion of the male pipe within the female pipe end openings.

10. The method of claim 2, wherein a companion restraint mechanism is provided for the elastomeric sealing ring which allows movement of the mating male pipe relative to the belled end of the female pipe in a first longitudinal direction but which restrains movement in a second, opposite relative direction, the restraint mechanism being located in the groove formed in the belled end of the female pipe section, and wherein the sealing gasket is joined to the restraint mechanism and trails outwardly from the bell end groove along a longitudinal axis of the female pipe.
